(19) United States
(12) Patent Application Publication
(10) Pub. No.: US 2019/0160644 A1
(43) Pub. Date: May 30, 2019

(54) PNEUMATIC ROTARY TOOL WITH AIRWAY SWITCHING STRUCTURE

(71) Applicant: DE POAN PNEUMATIC CORP., NEW TAIPEI CITY (TW)

(72) Inventors: I-TSUNG WU, NEW TAIPEI CITY (TW); YI-WEI WEN, NEW TAIPEI CITY (TW); SHUN-YAO YANG, NEW TAIPEI CITY (TW)

(21) Appl. No.: 16/019,508

(22) Filed: Jun. 26, 2018

(30) Foreign Application Priority Data
Nov. 28, 2017 (TW) 106141439
Apr. 17, 2018 (TW) 107113064

(51) Int. Cl. B25F 5/00; B25B 21/02; B25F 5/02

(52) U.S. Cl. CPC B25F 5/001; B25F 5/02; B25B 21/02

(57) ABSTRACT

A pneumatic rotary tool generally includes a housing, an air motor, a rotatable valve, and a dial ring. The housing defines therein an air chamber for receiving compressed air and is furnished with a drive lug at one end and an air inlet at an opposite end, wherein the air inlet communicates with the air chamber. The air motor is disposed in the housing between the drive lug and the air chamber and has an output shaft connected to the drive lug. The rotatable valve is rotatably disposed in the housing between the air motor and the air chamber. The dial ring is rotatably mounted around the housing, close to the air inlet, and coupled to the rotatable valve by a tube therebetween to enable the air motor to be switched between a forward rotation mode and a reverse rotation mode.

### (a) TECHNICAL FIELD OF THE INVENTION

The present invention relates to a pneumatic rotary tool for screwing/unscrewing objects and, more particularly, to a pneumatic rotary tool with an airway switching structure.

### (b) DESCRIPTION OF THE PRIOR ART

Pneumatic rotary tools are generally used to provide operators with the function of screwing and unscrewing bolts or nuts. The tool is usually provided with an air motor which receives compressed air to produce rotational kinetic energy output. Generally, the rotational kinetic energy is produced together with impact kinetic energy, so that nuts or bolts can be screwed more tightly or unscrewed more quickly

To screw/unscrew nuts or bolts, a pneumatic rotary tool should have the capability of conducting forward rotation and reverse rotation, and this relies on the compressed air received in the tool to have the air motor conduct the forward/reverse rotation, and the tools configured with airways corresponding to the forward rotation and the reverse rotation, respectively.

FIG. 1 shows a typical pneumatic rotary tool, which generally comprises a housing 10a constructed of a handle shell portion 101a, a motor shell portion 102a, and a head shell portion 103a. The handle shell portion 101a defines therein an air chamber for receiving high-pressure air. The motor shell portion 102a contains therein an air motor and a rotatable valve for switching airways to have the air motor conduct forward or reverse rotation. The head shell portion 103a is provided with a drive lug to which a socket can be connected. The air motor is located between the drive lug and the air chamber of the tool. The output shaft of the air motor is connected to the drive lug. Furthermore, the housing 10a is provided with a dial ring 50a between the handle shell portion 101a and the motor shell portion 102a. A user may turn the dial ring 50a by hand to rotate the rotatable valve so that the air motor can be switched between a forward rotation mode and a reverse rotation mode. Some airway switching mechanisms for pneumatic rotary tools have been disclosed in US Patent Publication No. 2013/0298755 A1 and US Patent Publication No. 2015/0275669 A1.

The dial ring 50a is located between the handle shell portion 101a and the motor shell portion 102a. Due to the dial ring 50a being located close to the drive lug, while a user conducts an operation, such as screwing/unscrewing nuts or bolts, it is inconvenient for the user to turn the dial ring for switching the operation mode of the pneumatic rotary tool. More specifically, while a user is operating the pneumatic tool at a narrow space, such as the chassis of a vehicle, for screwing/unscrewing nuts or bolts, the narrow space may cause the user inconvenience of turning the dial ring for switching the operational mode of the tool. There is a need for improvement.

### SUMMARY OF THE INVENTION

One object of the present invention is to provide a pneumatic rotary tool, which can solve the inconvenience of conventional tools in which the dial rings are located close to their drive lugs.

Generally, the pneumatic rotary tool comprises a housing, an air motor, a rotatable valve, and a dial ring. The housing is substantially cylindrical in shape and extends along a longitudinal axis. The housing defines therein an air chamber for receiving compressed air and is furnished with a drive lug at one end and an air inlet at an opposite end, wherein the air inlet communicates with the air chamber. The air motor is disposed in the housing between the drive lug and the air chamber, and has an output shaft connected to the drive lug. The rotatable valve is rotatably disposed in the housing along the longitudinal axis, between the air motor and the air chamber. The dial ring is rotatably mounted around the housing, with the longitudinal axis as a central axis, and close to the air inlet. The dial ring is coupled to the rotatable valve by a tube therebetween to enable the air motor to be switched between a forward rotation mode and a reverse rotation mode.

According to a first embodiment, the housing may be constructed of a grip shell, a motor shell, and a head shell which are aligned with the longitudinal axis and joined together. The air chamber is located in the grip shell. The air motor is located in the motor shell. The drive lug is located at the head shell. The air inlet is located at one end of the grip shell distal from the motor shell. The dial ring is located at the grip shell close to the air inlet.

According to a second embodiment, the housing may be constructed of a grip shell and a head shell which are aligned with the longitudinal axis and joined together. The air chamber is located in the shell. Both the air motor and the drive lug are located in the head shell. The air inlet is located one end of the grip shell distal from the head shell. The dial ring is located at the head shell close to the air inlet.

According to the first embodiment, the output shaft of the air motor is aligned with the longitudinal axis and at an angle to the drive lug.

According to the second embodiment, the output shaft of the air motor is not aligned with the longitudinal axis; namely, the output shaft of the air motor is at an angle to the longitudinal axis. The output shaft of the air motor is arranged coaxially with the drive lug.

More specifically, the rotatable valve defines therein an air guide channel along the longitudinal axis and has an air output face and an air input face respectively at its two opposite ends, wherein the air output face is adjacent to the air motor, and the air guide channel communicates with the air chamber via the air input face. The air output face of the rotatable valve is formed with an air intake section and an air discharge section, wherein the air intake section communicates with the air guide channel, and the air discharge section is spaced from the air intake section and communicates with an outside environment. The housing defines a discharge passage communicating with the outside environment. The air discharge section of the rotatable valve communicates with the outside environment via the discharge passage.

More specifically, an adaptive plate defining a first air port and a second air port is disposed in the housing between the air motor and the rotatable valve. The air motor communicates with the rotatable valve via the adaptive plate, wherein the first air port of the adaptive plate allows the compressed air to enter the air motor to conduct forward rotation, and the second air port of the adaptive plate allows the compressed air to enter the air motor to conduct reverse rotation. The rotatable valve is fitted with a spring to be urged against the adaptive plate.

In view of the foregoing, the technical effect of the present invention resides in that the dial ring is disposed at the rear end of the pneumatic rotary tool, and more specifically, the dial ring is located adjacent to the air inlet of the tool to facilitate a user turning the dial ring, especially at a narrow space, so that the air motor can be switched between a forward rotation mode and a reverse rotation mode more easily. As such, nuts or bolts can be screwed or unscrewed more easily.

Other objects, advantages, and novel features of the present invention will become more apparent from the following detailed description when taken in conjunction with the accompanying drawings.

### BRIEF DESCRIPTION OF THE DRAWINGS

FIG. 1 shows a 3-dimensional view of a pneumatic rotary tool of a prior art.

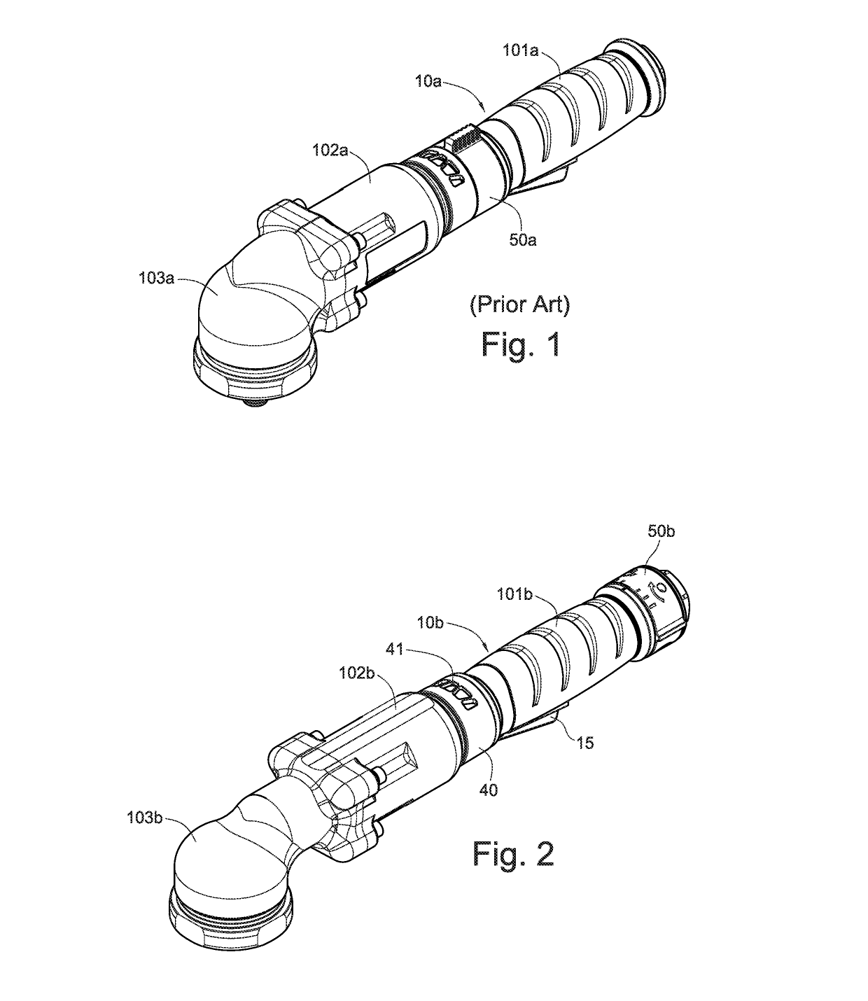

FIG. 2 shows a 3-dimensional view of a pneumatic rotary tool according to a first embodiment of the present invention.

FIG. 3 shows a partial sectional view of the pneumatic rotary tool of the first embodiment.

FIG. 4 shows a sectional view of the pneumatic rotary tool taken along line A-A in FIG. 3.

FIG. 5 shows a sectional view of the pneumatic rotary tool taken along line B-B in

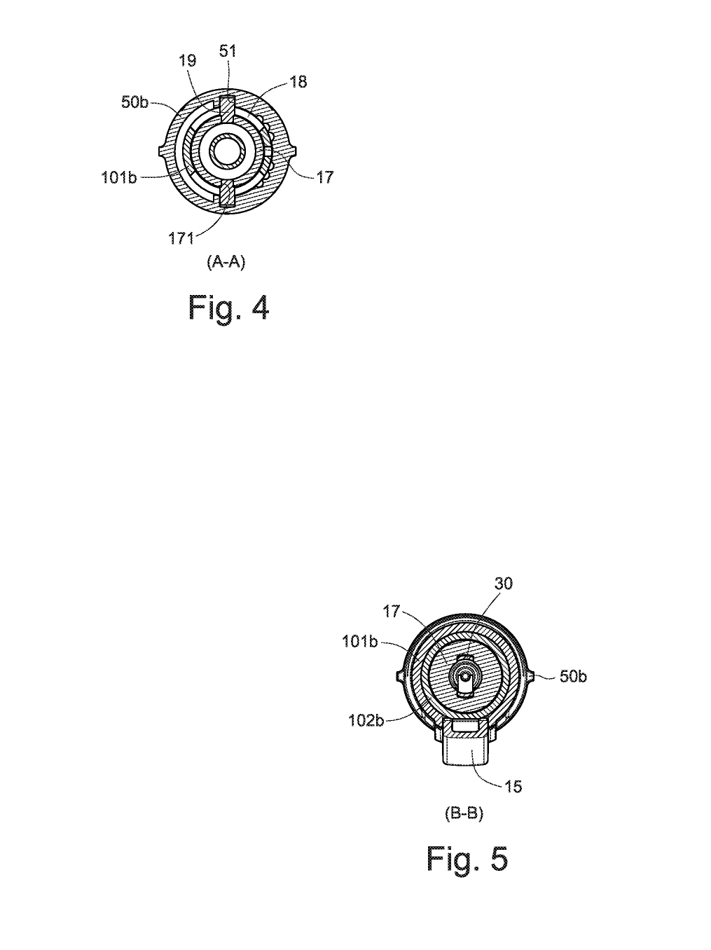

FIG. 3.

FIG. 6 shows a schematic working view of the pneumatic rotary tool, wherein the air motor is conducting forward rotation.

FIG. 7 shows a schematic working view of the pneumatic rotary tool, wherein the air motor is conducting reverse rotation.

FIG. 8 shows a sectional view of a pneumatic rotary tool according to a second embodiment of the present invention.

### DETAILED DESCRIPTION OF THE PREFERRED EMBODIMENTS

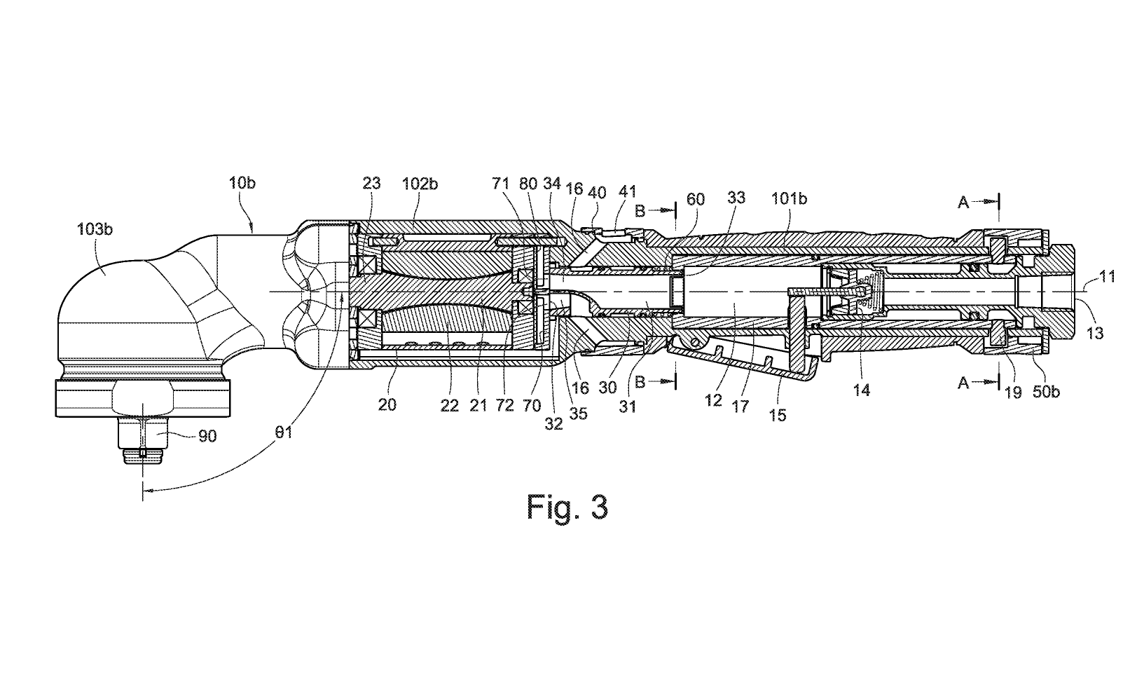

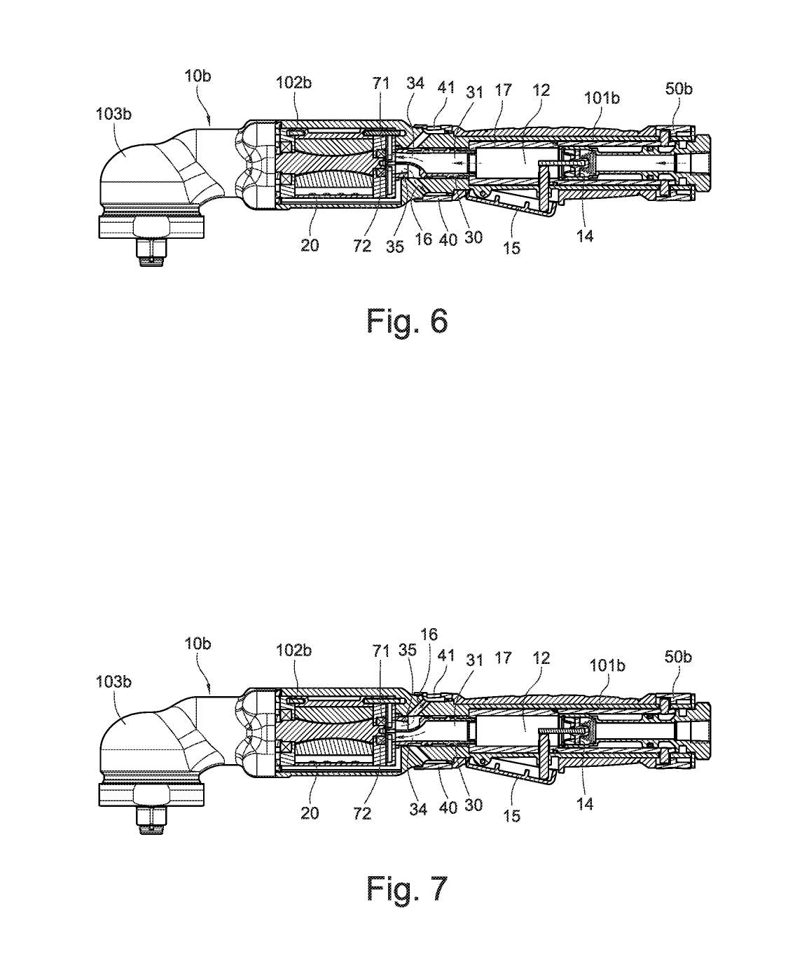

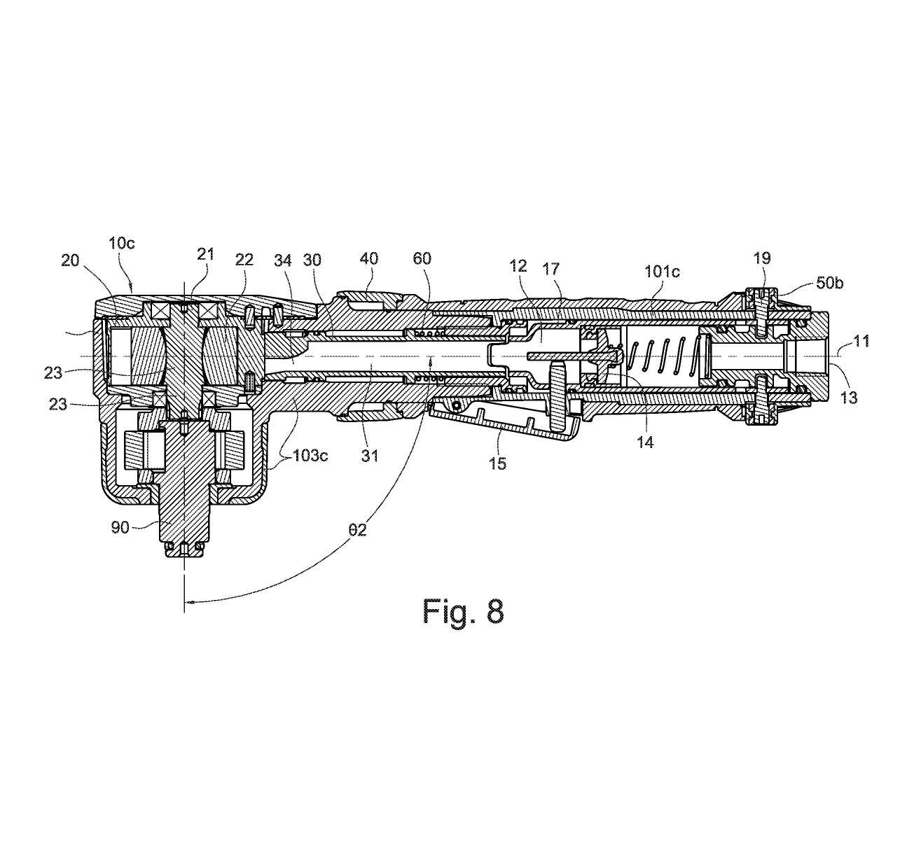

Referring to FIG. 2 through FIG. 5, a pneumatic rotary tool with an airway switching structure according to a first embodiment of the present invention is shown, which generally comprises a housing 10b, an air motor 20, a rotatable valve 30, and a dial ring 50b.

As shown in FIGS. 2 and 3, the housing 10b is cylindrical in shape and extends along a longitudinal axis 11, which allows the tool to be grasped more easily by hand. In practice, to facilitate installing the air motor 20 and the rotatable valve 30, the housing 10b can be constructed of a grip shell 101b, a motor shell 102b, and a head shell 103b, which are formed into an integral piece along the longitudinal axis 11 such that an air chamber 12 is defined in the grip shell 101b for receiving compressed or pressurized air, and an air inlet 13 is located at the grip shell 101b distal from the motor shell 102b in which the air motor 20 is installed. The air inlet 13 is located at the rear end of the pneumatic rotary tool, and this facilitates the air inlet 13 being connected to an air compressor which supplies compressed air to the air chamber 12.

A throttle valve 14 is provided at one end of the air chamber 12. The grip shell 101b is provided at one side with a trigger 15. When a user depresses the trigger 15, the throttle valve 14 can be opened, so that compressed air can be introduced into the air chamber 12 via the air inlet 13; on the other hand, when the user releases the trigger 15, the throttle valve 14 can be closed so that compressed air can be blocked from entering the air chamber 12.

The motor shell 102b defines therein a stepped hole, in which the air motor 20 and the rotatable valve 30 along the longitudinal axis 11 are disposed. A discharge passage 16 communicating with the outside environment or atmosphere are defined at a peripheral wall of the motor shell 102b of the housing 10b. Furthermore, an annular element 40 with vent distribution holes 41, which communicates with the outside environment, can be fitted around the motor shell 102b at a location where the discharge passages 16 communicate with the outside environment. The vent distribution holes 41 communicate with the discharge passage 16 so that the air passing through the air motor 20 can be released into the outside environment. Also, the annular element 40 may serve as a buffer for the air discharged from the discharge passages 16, thus avoiding the discharged air impacting on a user's hand to cause discomfort.

Specifically, the air motor 20 includes a rotor 21 provided with a plurality of movable vanes 22. The rotor 21 can be rotated by compressed air acting on the vanes 22. An output shaft 23 extends in the direction of the longitudinal axis 11 from one end of the rotor 21 to the head shell 103b. In this embodiment, the drive lug 90 provided at the head shell 103b is not aligned with the longitudinal axis 11. As such, the drive lug 90 is at an angle (θ1) to the output shaft 23 of the air motor 20. In FIG. 3, the angle (θ1) is 90 degrees, but not limited thereto. In order to couple the output shaft 23 of the air motor 20 to the drive lug 90, the output shaft 23 and the drive lug 90 can be provided with two bevel gears (not shown), respectively. Through the two meshed bevel gears, the output shaft 23 of the air motor 20 can drive the drive lug 90 to rotate. Nevertheless, the output shaft 23 and the drive lug 90 can be coupled together by other ways.

Referring again to FIGS. 3 through 5, the rotatable valve 30 is a substantially cylindrical shell rotatably mounted in the motor shell 102b between the air motor 20 and the air chamber 12. A tube 17 is rotatably mounted in the grip shell 101b between the rotatable valve 30 and the dial ring 50b. The tube 17 extends from a first location, to which the rotatable valve 30 is connected, to a second location, which is distal from the motor shell 102b and at which the dial ring 50b is installed. Two holes 171 are defined at two sides of the tube 17 corresponding to the second location, and two engagement pins 19 are respectively inserted into the two holes 171 in a radial direction of the rotatable valve 30. More specifically, the air chamber 12 is defined in the tube 17.

In addition, an arcuate slot 18 is defined at the grip shell 101b, with the longitudinal axis 11 as a central axis, and close to the air inlet 13. The dial ring 50b is provided over the arcuate slot 18 and defines at its inner surface two recesses 51 each for receiving one end of one engagement pin 19 inserted through a corresponding arcuate slot 18 and into a corresponding hole 171 of the tube 17. As such, a user may turn the dial ring 50b by hand to have the engagement pins 19 rotate the rotatable valve 30. Also, the arcuate slots 18 can limit the rotation angle of the engagement pins 19, so that the rotatable valve 30 can be rotated to a first position, at which the air motor 20 conducts forward rotation, or a second position, at which the air motor 20 conducts reverse rotation.

Furthermore, as shown in FIG. 3, the rotatable valve 30 defines therein an air guide channel 31 along the longitudinal axis and is provided at its two ends with an air output face 32 and an air input face 33. The air guide channel 31 extends through the air input face 33. The air guide channel 31 communicates with the air chamber 12 via the air input face 33. The air output face 32 of the rotatable valve 30 is adjacent to the air motor 20. When there are no other elements (such as an adaptive plate 70 described below) located between the rotatable valve 30 and the air motor 20, the air output face 32 may be disposed to abut the air motor 20.

The air output face 32 is formed with an air supply section 34 and an air discharge section 35 spaced from the air supply section 34, wherein the air supply section 34 communicates with the air guide channel 31, and the air discharge section 35 can communicate with one of the discharge passages 16 defined at the motor shell 102b. More specifically, as shown in FIG. 3, the air supply section 34 and the air discharge section 35 are respectively located at two sides of the longitudinal axis. 11, wherein the air discharge section 35 extends along a curve to join one of the discharge passages 16, so that the air discharge section 35 can communicate with the outside environment.

Furthermore, the rotatable valve 30 can be fitted with a compression spring 60. As an example, one end of the spring is urged against an annular protrusion formed at the outer surface of the rotatable valve 30 while another end of the spring is urged against the tube 17 (see FIG. 3). As such, the compression spring 60 can exert a forward force onto the rotatable valve 30, so that the air output face 32 of the rotatable valve 30 can be forced to move towards or even touch the air motor 20.

Furthermore, as shown in FIG. 3, an adaptive plate 70 may be disposed in the motor shell 102b. The adaptive plate 70, which is generally in the shape of a disk, is located between the air motor 20 and the air output face 32 of the rotatable valve 30. Furthermore, the adaptive plate 70 defines therethrough a first air port 71 and a second air port 72 at two sides of the longitudinal axis 11. In addition, an airtight gasket 80 can be disposed between the adaptive plate 70 and the air motor 20. The airtight gasket 80 is used to enhance the airtightness between the adaptive plate 70 and the air motor 20.

The purpose of the adaptive plate 70 is to enable the motor 20 to be connected to the air output face 32 of the rotatable valve 30, because the air motor 20 has a diameter different from the output face 32. As such, compressed air can enter the air motor 20 via the adaptive plat 70. However, in the present invention, the adaptive plate 70 is an optional element, but not an indispensable element.

In use, referring to FIG. 6, when the rotatable valve 30 is rotated to the first position, the air supply section 34 of the rotatable valve 30 can communicate with the air motor 20 via the first air port 71 of the adaptive plate 70. The air discharge section 35 of the rotatable valve 30 can communicate with the air motor 20 via the second air port 72 of the adaptive plate 70, so that the compressed air in the air guide channel 31 of the rotatable valve 30 can flow into the air motor 20 via the air supply section 34 and the first air port 71, causing the output shaft 23 of the air motor 20 to rotate in a forward direction. The compressed air driving the air motor 20 to rotate forwardly can pass through the second air port 72 of the adaptive plate 70, the air discharge section 35 of the rotatable valve 30, one discharge passage 16, and the distribution vent holes 41 to be released into the outside environment.

Referring now to FIG. 7, when the rotatable valve 30 is turned to the second position, the air supply section 34 of the rotatable valve 30 can communicate with the air motor 20 via the second air port 72 of the adaptive plate 70. The air discharge section 35 of the rotatable valve 30 can communicate with the air motor 20 via the first air port 71 of the adaptive plate 70, so that the compressed air in the air guide channel 31 of the rotatable valve 30 can flow into the air motor 20 via the air supply section 34 and the second air port 72, causing the output shaft 23 of the air motor 20 to rotate in a reverse direction. The compressed air driving the air motor 20 to rotate reversely can pass through the first air port 71 of the adaptive plate 70, the air discharge section 35 of the rotatable valve 30, one discharge passage 16, and the distribution vent holes 41 to be released into the outside environment.

Furthermore, in one embodiment installed with the adaptive plate 70, the compression spring 60 fitted around the rotatable valve 30 can push the rotatable valve 30 to move forwardly, so that the air output face 32 of the rotatable valve 30 can be disposed in tight contact with the adaptive plate 70.

FIG. 8 shows a second embodiment of the pneumatic rotary tool of the present invention, which is different from the first embodiment in that:

The housing 10c is formed by two shells, including a grip shell 101c and a head shell 103c, which are joined together along the longitudinal axis 11.

In this embodiment, the head shell 103c, which can be a component similar to the motor shell 102b and the head shell 103b used in the first embodiment, can be obtained by combining the motor shell 102b and the head shell 103b to form into an integral piece. The air motor 20, the rotatable valve 30, and the drive lug 90 are disposed in the outer shell 103c, wherein the rotatable valve 30 is disposed along the longitudinal axis 11. The air motor 20 is disposed such that the output shaft 23 thereof is not aligned with the longitudinal axis 11; in other words, the output shaft 23 of the air motor 20 is at an angle (θ2) to the longitudinal axis 11. In FIG. 8, the angle (θ2) is 90 degrees, but not limited thereto. In practice, the drive lug 90 is disposed coaxially with the output shaft 23 of the air motor 20, so that the air motor 20 can rotate the drive lug 90 directly.

The above embodiments illustrate preferred ways for implementing the present invention. However, they are not intended to limit the scope of the present invention. Accordingly, the scope of the present invention should be interpreted from the claims hereinafter appended.

What is claimed is:

1. A pneumatic rotary tool, comprising:
a housing being substantially cylindrical in shape and extending along a longitudinal axis, the housing defining therein an air chamber for receiving compressed air, and provided with a drive lug at one end and an air inlet at an opposite end, the air inlet communicating with the air chamber;
an air motor disposed in the housing between the drive lug and the air chamber, the air motor having an output shaft connected to the drive lug;
a rotatable valve rotatably disposed in the housing along the longitudinal axis between the air motor and the air chamber; and
a dial ring rotatably mounted around the housing, with the longitudinal axis as a central axis, and close to the air inlet, the dial ring being coupled to the rotatable valve by a tube therebetween to enable the air motor to be switched between a forward rotation mode and a reverse rotation mode.

2. The pneumatic rotary tool of claim 1, wherein the housing is constructed of a grip shell, a motor shell, and a head shell which are aligned with the longitudinal axis and formed together, the air chamber located in the grip shell, the air motor located in the motor shell, the drive lug located at the head shell.

3. The pneumatic rotary tool of claim 2, wherein the air inlet is located at one end of the grip shell distal from the motor shell; the dial ring is located at the grip shell close to the air inlet.

4. The pneumatic rotary tool of claim 1, wherein the housing is constructed of a grip shell and a head shell which are aligned with the longitudinal axis and joined together, the air chamber located in the grip shell, both the air motor and the drive lug located in the head shell.

5. The pneumatic rotary tool of claim 4, wherein the air inlet is located at one end of the grip shell distal from the head shell; the dial ring is located at the head shell close to the air inlet.

6. The pneumatic rotary tool of claim 1, wherein the output shaft of the air motor is aligned with the longitudinal axis.

7. The pneumatic rotary tool of claim 6, wherein the output shaft of the air motor is at a predetermined angle to the drive lug.

8. The pneumatic rotary tool of claim 1, wherein the output shaft of the air motor is not aligned with the longitudinal axis.

9. The pneumatic rotary tool of claim 8, wherein the output shaft of the air motor is at a predetermined angle to the longitudinal axis.

10. The pneumatic rotary tool of claim 9, wherein the output shaft of the air motor is arranged coaxially with the drive lug.

11. The pneumatic rotary tool of claim 1, wherein the rotatable valve defines therein an air guide channel along the longitudinal axis and has an air output face and an air input face respectively at its two opposite ends, the air output face being adjacent to the air motor, the air guide channel communicating with the air chamber via the air input face.

12. The pneumatic rotary tool of claim 11, wherein the air output face of the rotatable valve is formed with an air intake section and an air discharge section, the air intake section communicating with the air guide channel, the air discharge section being spaced from the air intake section and communicating with an outside environment.

13. The pneumatic rotary tool of claim 12, wherein the housing defines a discharge passage communicating with the outside environment, the air discharge section of the rotatable valve communicating with the outside environment via the discharge passage.

14. The pneumatic rotary tool of claim 1, wherein an adaptive plate defining a first air port and a second air port is disposed in the housing between the air motor and the rotatable valve, the air motor communicating with the rotatable valve via the adaptive plate, wherein the first air port of the adaptive plate allows compressed air to enter the air motor to conduct forward rotation, and the second air port of the adaptive plate allows compressed air to enter the air motor to conduct reverse rotation.

15. The pneumatic rotary tool of claim 14, wherein the rotatable valve is fitted with a spring to be urged against the adaptive plate.
